(19) United States
(12) Patent Application Publication
(10) Pub. No.: US 2019/0009666 A1
(43) Pub. Date: Jan. 10, 2019

(54) TRANSMISSION FOR VEHICLE

(71) Applicants: HYUNDAI MOTOR COMPANY, Seoul (KR); KIA MOTORS CORPORATION, Seoul (KR)

(72) Inventors: Soon Ki EO, Ansan-si (KR); Ki Jong PARK, Hwaseong-si (KR); Won Min CHO, Hwaseong-si (KR); Woo Churl SON, Seongnam-si (KR); Ki Dong KIM, Anyang-si (KR); Sun Sung KWON, Anyang-si (KR); Cheol Ho JANG, Busan (KR)

(73) Assignees: HYUNDAI MOTOR COMPANY, Seoul (KR); KIA MOTORS CORPORATION, Seoul (KR)

(21) Appl. No.: 15/808,241

(22) Filed: Nov. 9, 2017

(30) Foreign Application Priority Data
Jul. 4, 2017 (KR) 10-2017-0084935

(51) Int. Cl. B60K 6/48; F16H 3/00; F16H 3/085; B60K 6/36; B60K 6/547

(52) U.S. Cl. CPC B60K 6/48; F16H 3/006; B60K 2006/541; B60K 6/36; B60K 6/547; F16H 3/085

(57) ABSTRACT

A transmission for a vehicle includes: a first input shaft IS1 disposed to be selectively supplied with power from an engine E; a second input shaft IS2 disposed to be selectively supplied with power from the engine E; a motor M disposed to be always connected to either the first input shaft IS1 or the second input shaft IS2 through a transmission gear unit to transmit power; a first output shaft OS1 and a second output shaft OS2 disposed in parallel with the first input shaft IS1 and the second input shaft IS2; a first driven gear unit U1P including a plurality of driven gears; a second driven gear unit U2P including a plurality of driven gears; a plurality of synchronizer devices provided on the first output shaft OS1 and the second output shaft OS2; and a connecting device SL selectively connecting two driven gears to each other.

### CROSS REFERENCE TO RELATED APPLICATION

The present application claims priority to and the benefit of Korean Patent Application No. 10-2017-0084935, filed on Jul. 4, 2017, which is incorporated herein by reference in its entirety.

### FIELD

The present disclosure relates to a transmission for a vehicle having a relatively simple and compact structure while improving shift feeling and ride comfort.

### BACKGROUND

The statements in this section merely provide background information related to the present disclosure and may not constitute prior art.

The conventional automated manual transmission (AMT) has a clutch actuator for interrupting a clutch and a shift actuator for releasing a previous shift stage and engaging a desired target shift stage to drive the clutch actuator and the shift actuator in response to a driving state of the vehicle, thereby automatically performing a speed change.

However, since the existing AMT as described above needs to interrupt a torque input from the clutch actuator to the AMT in order to release the previous shift stage and engage a new target shift stage by driving the shift actuator, such that a torque interruption which interrupts a torque to be provided from an engine to a driving wheel occurs. This greatly reduces ride comfort as well as shift feeling of a vehicle.

### SUMMARY

The present disclosure proposes a transmission for a vehicle having a relatively simple and compact structure while improving shift feeling and ride comfort by reducing a torque interruption, and the transmission also improves mountability of the vehicle and fuel efficiency.

According to an exemplary form of the present disclosure, a transmission for a vehicle may include: a first input shaft IS1 disposed to be selectively supplied with power from an engine E; a second input shaft IS2 disposed to be selectively supplied with power from the engine E; a motor M disposed to be always connected to either the first input shaft IS1 or the second input shaft IS2 through a transmission gear unit to transmit power; a first output shaft OS1 and a second output shaft OS2 disposed in parallel with the first input shaft IS1 and the second input shaft IS2; a first driven gear unit U1P forming a hollow shaft surrounding an outer side of the first output shaft IS1 and including a plurality of first driven gears, some of the plurality of first driven gears (i.e., driven gears of the first driven gear unit) configured to engage with driving gears provided on the first input shaft IS1 and the second input shaft IS2; a second driven gear unit U2P forming a hollow shaft surrounding an outer side of the second output shaft IS2 and including a plurality of second driven gears, some of the plurality of second driven gears (i.e., driven gears of the second driven gear unit) configured to engage with the driving gears provided on the first input shaft IS1 and the second input shaft IS2; a plurality of synchronizer devices provided on the first output shaft OS1 and the second output shaft OS2 and configured to connect any one of the first and second driven gear units U1P and U2P to a corresponding output shaft selected from the first and second output shafts; and a connecting device SL configured to selectively connect two second driven gears selected from the plurality of second driven gears, wherein each of the selected two second driven gears is connected to a different input shaft selected from the first and second input shafts.

The first input shaft IS1 may be connected to the engine E through a first clutch C1 and the second input shaft IS2 may be formed as a hollow shaft surrounding an outer side of the first input shaft IS1 and may be connected to the engine E through a second clutch C2.

The motor M may be always connected to the first input shaft IS1 through a transmission gear unit, and a specific shift stage other than an R-stage among shift stages to be implemented may be implemented by controlling any one of the synchronizer devices to connect a single first driven gear connected to the second input shaft IS2 to the first output shaft OS1 while the connecting device SL interconnecting the two second driven gears each other.

The number of first and second driven gears of the first and second driven gear units U1P and U2P may be set to be equal to a number of the shift stages to be implemented excluding the specific shift stage and the R-stage.

The transmission for a vehicle may further include: a parking gear P provided on either the first output shaft OS1 or the second output shaft OS2 to prevent the output shaft from rotating.

Further areas of applicability will become apparent from the description provided herein. It should be understood that the description and specific examples are intended for purposes of illustration only and are not intended to limit the scope of the present disclosure.

### DRAWINGS

The above and other objects, features and advantages of the present disclosure will be more clearly understood from the following detailed description taken in conjunction with the accompanying drawings, in which:

FIG. 1 is a view illustrating a transmission for a vehicle in a first exemplary form of the present disclosure;

FIGS. 2 and 3 are views illustrating a power flow at the time of starting of an engine of the transmission for a vehicle of FIG. 1;

FIGS. 4 and 5 are views illustrating a power flow at the time of motor idle charging of the transmission for a vehicle of FIG. 1;

FIGS. 6 to 9 are views illustrating a power flow in EV mode first to third shift stages and fifth shift stage of the transmission for a vehicle of FIG. 1;

FIGS. 10 to 15 are views illustrating a power flow in EV mode first to sixth shift stages of the transmission for a vehicle of FIG. 1; and

FIGS. 16 to 21 are diagrams illustrating a transmission for a vehicle in second to seventh exemplary forms of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

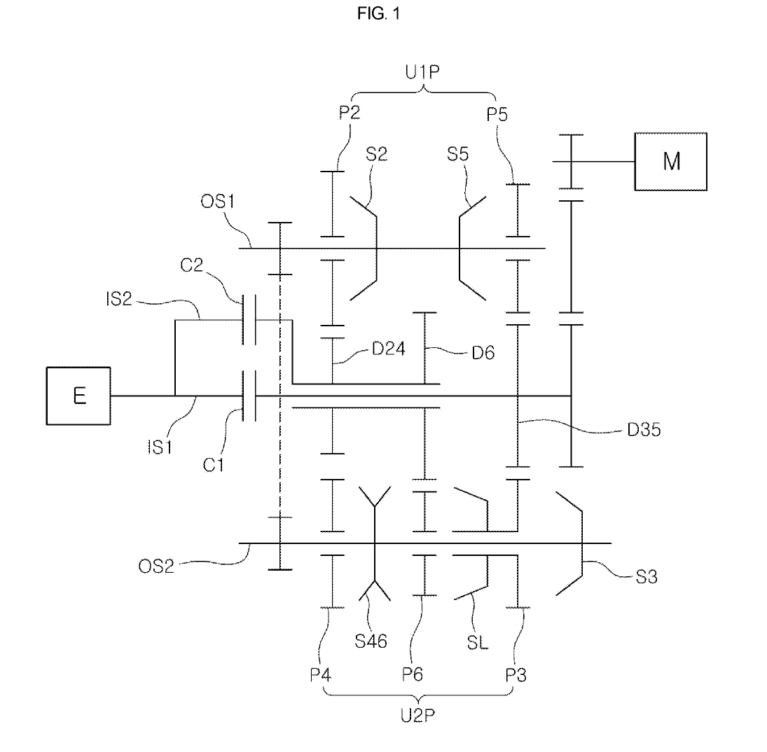

FIG. 1 is a view illustrating a transmission for a vehicle in a first exemplary form of the present disclosure.

Referring to FIG. 1, a transmission for a vehicle includes: a first input shaft IS1 disposed to be selectively supplied with power from an engine E; a second input shaft IS2 disposed to be selectively supplied with power from the engine E; a motor M disposed to be always connected to either the first input shaft IS1 or the second input shaft IS2 through a transmission gear unit to transmit power; a first output shaft OS1 and a second output shaft OS2 disposed in parallel with the first input shaft IS1 and the second input shaft IS2; a first driven gear unit U1P forming a hollow shaft surrounding an outer side of the first output shaft IS1 and including a plurality of first driven gears; a second driven gear unit U2P forming a hollow shaft surrounding an outer side of the second output shaft IS2 and including a plurality of second driven gears; a plurality of synchronizer devices provided on the first output shaft OS1 and the second output shaft OS2 to connect any one of the first and second driven gear units U1P and U2P to a corresponding output shaft; and a connecting device SL selectively connecting two second driven gears connected to different input shafts to each other.

In particular, some of the first driven gears of the first driven gear unit U1P are engaged with driving gears provided on the first input shaft IS1 and the second input shaft IS2, and similarly, some of second driven gears of the second driven gear unit U2P are engaged with the driving gears provided on the first input shaft IS1 and the second input shaft IS2.

Here, the first input shaft IS1 is connected to the engine E through a first clutch C1, and the second input shaft IS2 is formed as the hollow shaft surrounding the first input shaft IS1 and may be provided to be connected to the engine E through the second clutch C2.

Here, the engine E is connected to the first and second input shafts IS1 and IS2 through the first and second clutches C1 and C2, and the motor M is directly connected to the input shaft IS1 or the second input shaft IS2 through the separate transmission gear unit, such that there is no need to apply the engine clutch to interrupt power between the engine E and the motor M as in the related art. Therefore, in the forms of the present disclosure, the engine clutch can be removed to reduce the full length and weight of the transmission.

Particularly, according to the present disclosure, since the motor M is connected to only either one of the first input shaft IS1 and the second input shaft IS2, it is desired a structure of transmitting power through the remaining input shafts that are not directly connected to the motor M.

Accordingly, the connecting device SL is provided to selectively connect two second driven gears, and each of the two second driven gears is connected to different input shafts. For example, one of the two second driven gears of the second driven gear unit U2P provided on the second output shaft OS2 is connected to the first input shaft IS1 , and the other second driven gear is connected to the second input shaft IS2, and then the connecting device SL selectively connects the two second driven gears to each other.

Therefore, it is possible to implement various vehicle driving modes in such a manner that the motor is charged by variably transmitting the power of the motor M to the first input shaft IS1 or the second input shaft IS2 or transmitting the power of the engine E to the motor M through the first input shaft IS1 or the second input shaft IS2.

In the transmission for a vehicle according to the first form of the present disclosure, the motor M is disposed to be always connected to the first input shaft IS1 through a transmission gear unit.

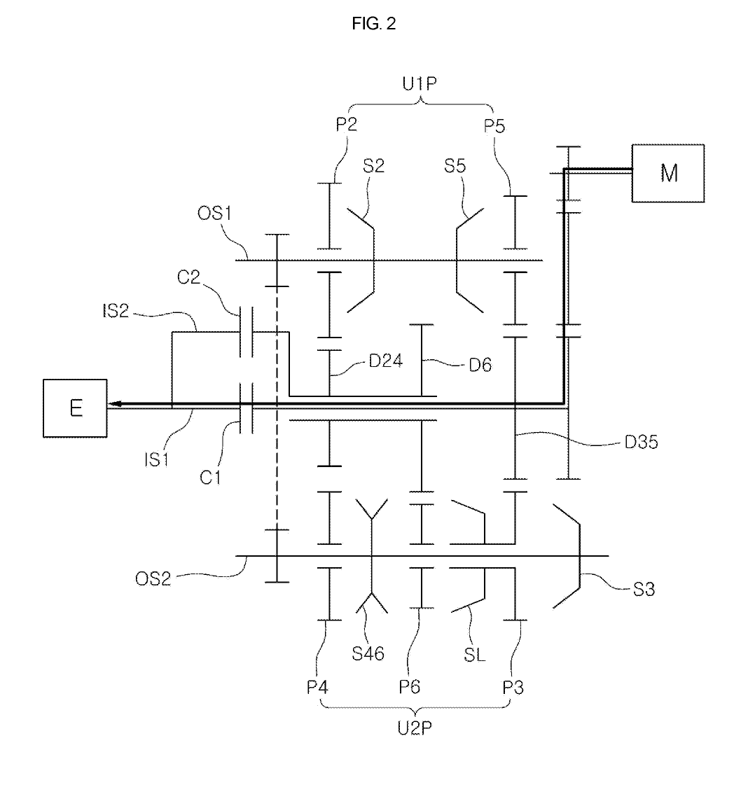

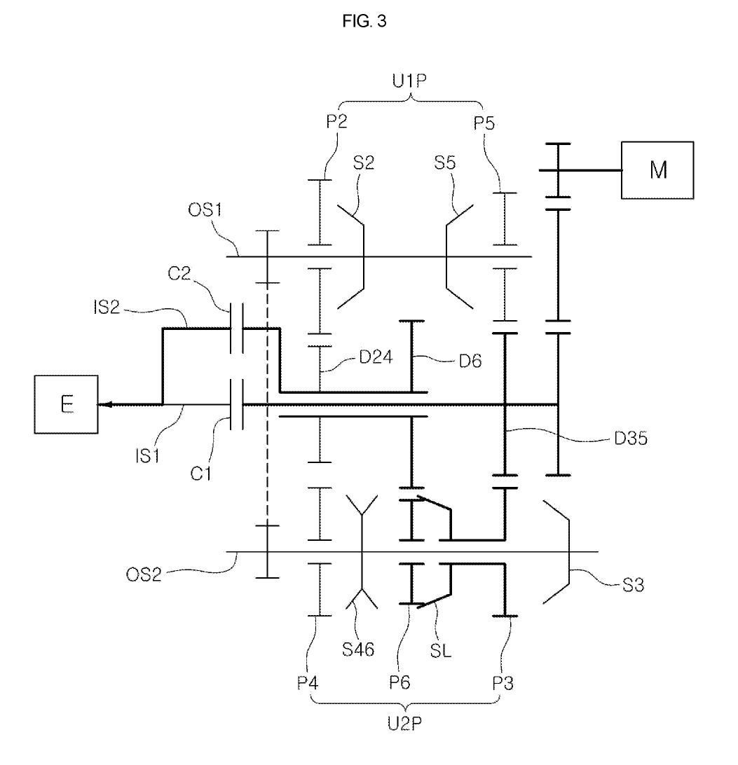

FIGS. 2 and 3 are views illustrating a power flow at the time of starting of an engine of the transmission for a vehicle of FIG. 1.

That is, in order to start the engine E by using the power of the motor M, the first clutch C1 is engaged as illustrated in FIG. 2 or the second clutch C2 is engaged as illustrated in FIG. 3 to operate the connecting device SL, thereby starting the engine E with the power of the motor M.

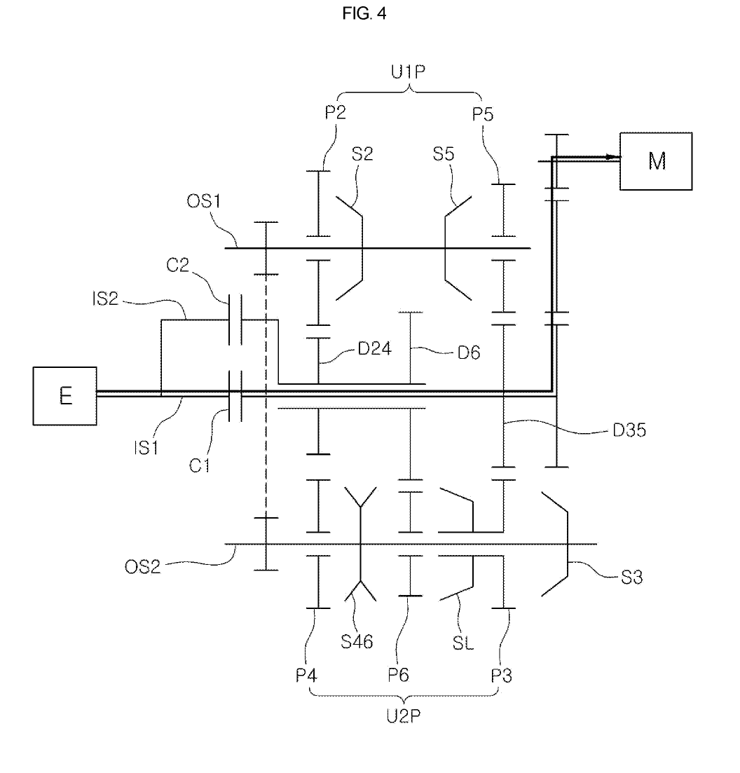

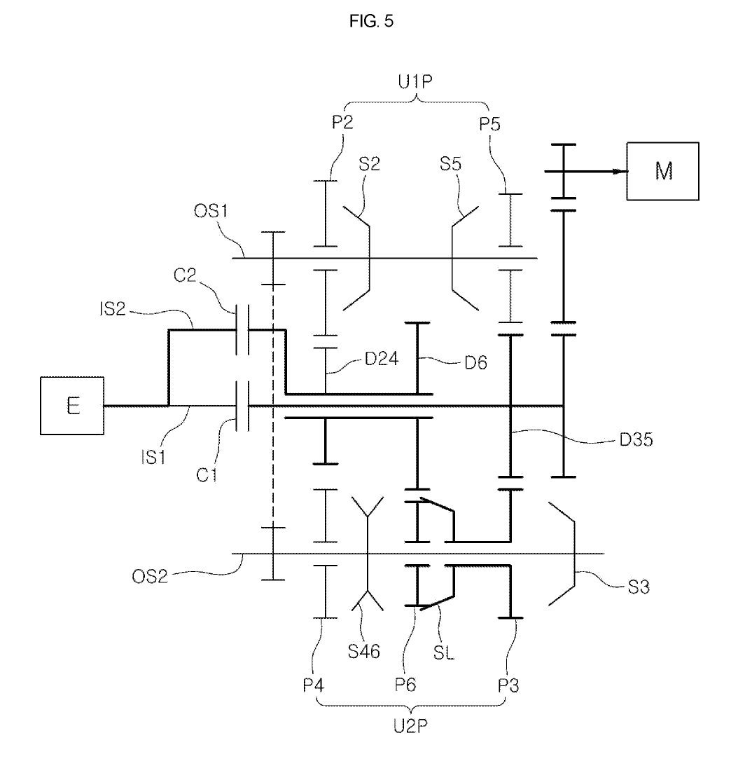

To the contrary, FIGS. 4 and 5 are views illustrating a power flow at the time of motor idle charging of the transmission for a vehicle of FIG. 1.

That is, when the engine E starts and thus is in an idle state, as illustrated in FIG. 4, only the first clutch C1 may be engaged to charge the motor M as illustrated in FIG. 4, and as illustrated in FIG. 5, the second clutch C2 may be engaged to operate the connecting device SL, thereby charging the motor M.

Therefore, since the method of starting the engine E or charging the motor M in the idle state can be implemented in two types, it is possible to perform the transmission operation normally even when any one of the two types is impossible.

In one form of the present disclosure, among shift stages to be implemented, a specific shift stage except an R-stage may be implemented by controlling one of the synchronizer devices to connect, among the plurality of first driven gears included in the first driven gear unit U1P, a single first driven gear connected to the second input shaft IS2 to the first output shaft OS1, while the connecting device SL is interconnecting, among the plurality of second driven gears included in the second driven gear unit U2P, the two second driven gears connected to the different input shafts to each other.

Accordingly, the number of driven gears configuring the first and second driven gear units U1P and U2P may be set to be a number of the shift stages to be implemented excluding the specific shift stage and the R-stage.

For the sake of understanding, if it is assumed that the shift stages to be implemented by the transmission for a vehicle are the R-stage and first to sixth stages, and if it is assumed that the specific shift stage is the 1-stage, the number of driven gears configuring the first and second driven gear units U1P and U2P is five.

Referring to FIG. 1, according to the first form of the present disclosure, the driven gears connected to each other by the connecting device SL are a 3-stage driven gear P3 and a 6-stage driven gear P6, and the driven gear connected to the second input shaft IS2 out of the first driven gear unit U1P is a 2-stage driven gear P2. At this time, power is transmitted to the output shaft through the 3-stage driven gear P3, the 5-stage driven gear P6, and the 2-stage driven gear P2 so that the vehicle is driven at a 1-stage gear ratio.

As described above, since the power of the engine E or the motor M can be transmitted to the output shaft through two or more transmission gear units by using the connecting device SL, a transmission ratio larger than the number of transmission gear units can be implemented, thereby reducing the volume and weight of the transmission.

According to the transmission for a vehicle in one form of the present disclosure, EV driving can be made by a total of five shift stages.

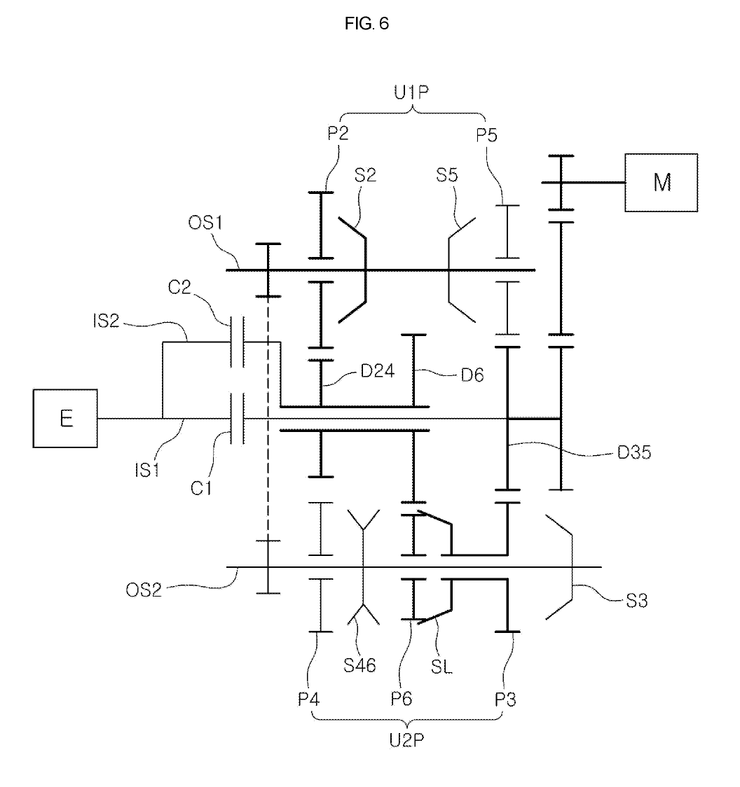

FIGS. 6 to 9 are views illustrating a power flow in EV mode 1 to 3 shifts and 5 shift of the transmission for a vehicle of FIG. 1. For the sake of understanding, the specific shift stage is established to be 1-stage.

As illustrated in FIG. 6, if the driving mode of the vehicle is EV mode 1-stage, the first and second clutches C1 and C2 are released and the connecting device SL and the two-stage synchronizer device S2 are operated, thereby implementing an EV 1-stage mode. That is, the power of the motor M is transmitted to the first output shaft OS while passing through the 3-stage gear set, the 6-stage gear set, and the 2-stage gear set, such that a 1-stage transmission ratio may be implemented. If the motor M rotates reversely in this state, the vehicle drives in an EV R-stage mode.

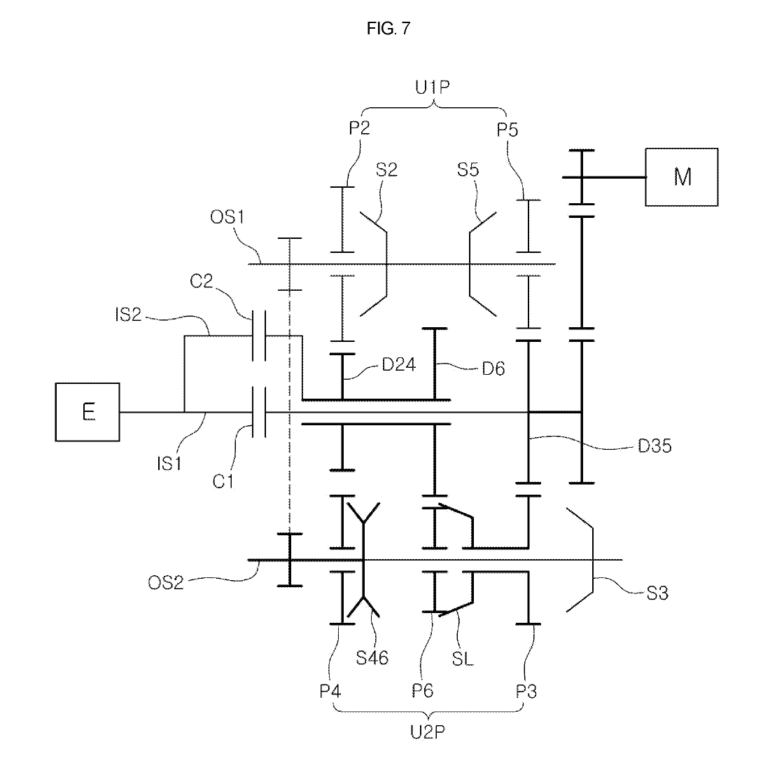

If the driving mode of the vehicle is an EV mode 2-stage as illustrated in FIG. 7, the connecting device SL and 4 and 6-stages synchronizer devices S46 are operated to a 4-stage driven gear P4 side, thereby implementing an EV 2-stage mode. In one form, the power of the motor M is provided so as to realize a 2-stage transmission ratio through a 3-stage gear set, a 6-stage gear set, and a 4-stage gear set.

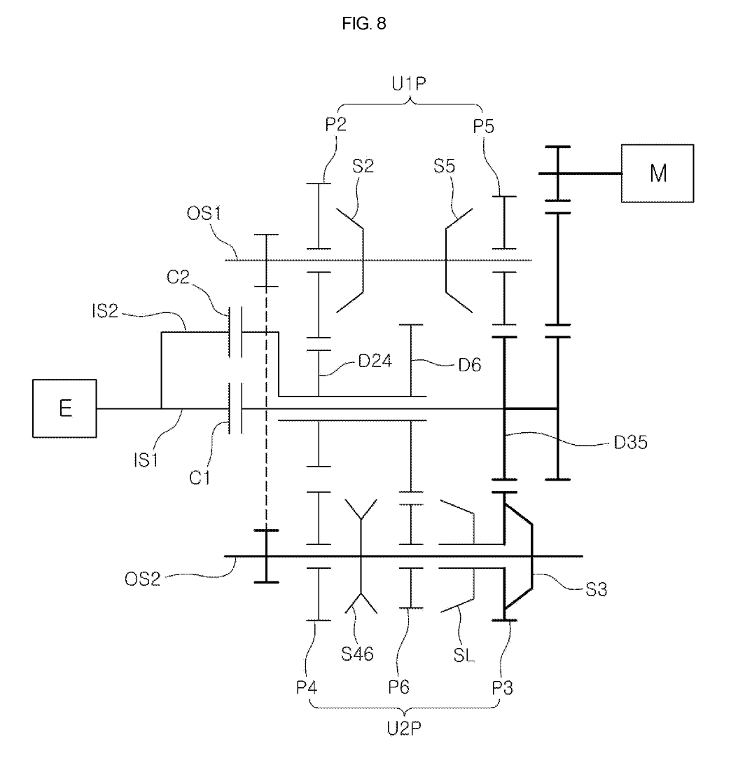

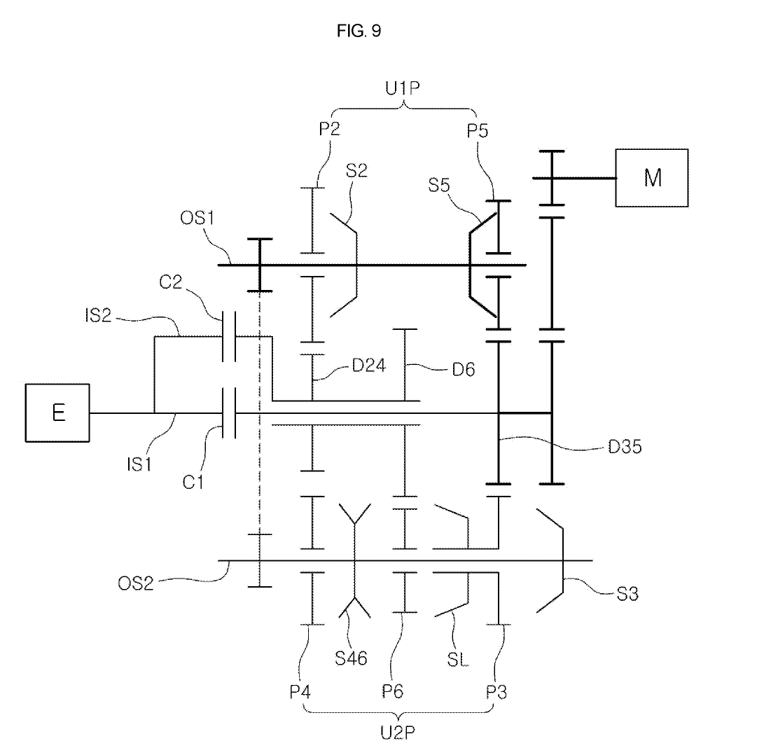

If the driving mode of the vehicle is an EV 3-stage mode, the 3-stage synchronizer device (S3) is operated as illustrated in FIG. 8, and if the driving mode of the vehicle is an EV 5-stage stage mode, a 5-stage synchronizer device (S5) is operated as illustrated in FIG. 9.

Further, the transmission for a vehicle of the present disclosure is capable of HEV driving in 7 shift stages.

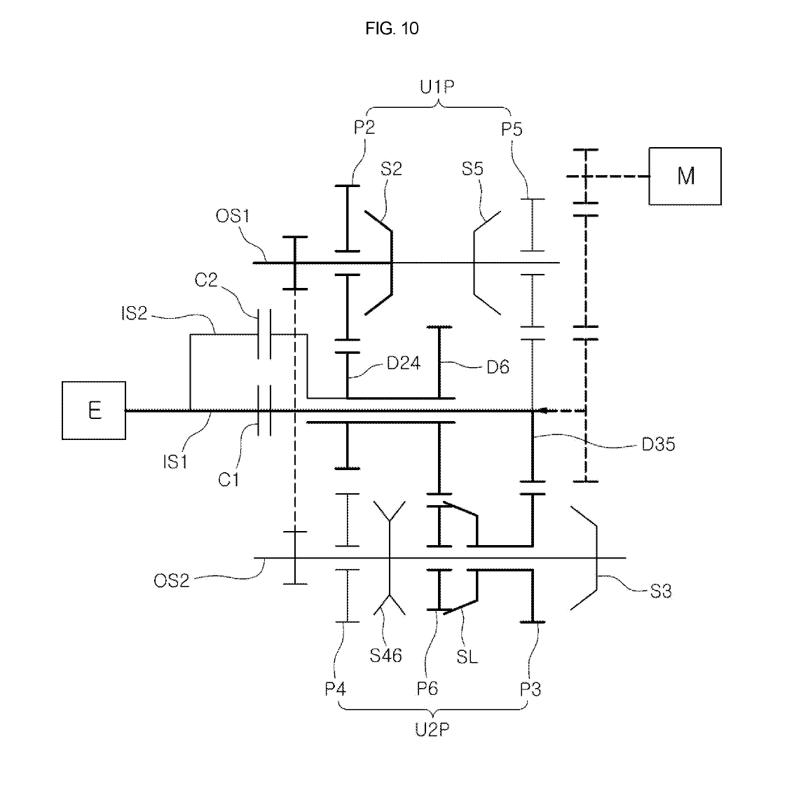

FIGS. 10 to 15 are views illustrating a power flow in EV mode 1 to 6 stages of the transmission for a vehicle of FIG. 1.

If the driving mode of the vehicle is an HEV 1-stage, as illustrated in FIG. 10, the connecting device SL and the second synchronizer device S2 are operated and the first clutch C1 is engaged to transmit the power of the engine E to the output shaft through the 3-stage gear set, the 6-stage gear set, and the 2-stage gear set, thereby implementing the 1-stage transmission ratio. At this time, the motor M may selectively transmit auxiliary power to the first input shaft IS1.

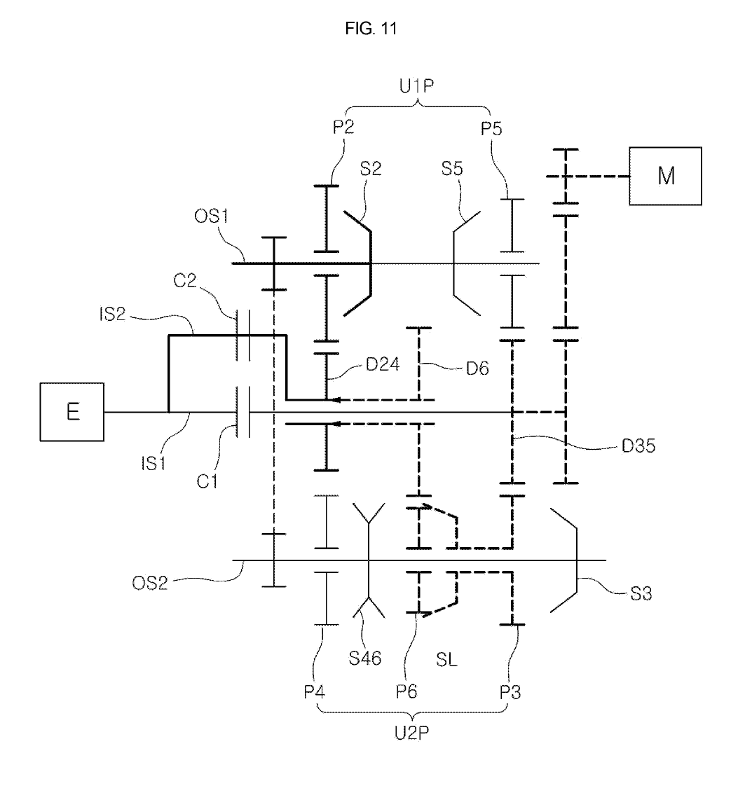

In the case of the HEV 2-stage, as illustrated in FIG. 11, the second synchronizer device S2 is operated and the second clutch C2 is engaged, thereby implementing the 2-stage HEV driving mode. At this time, if the auxiliary power is to be transmitted through the motor M, the connecting device may be selectively connected.

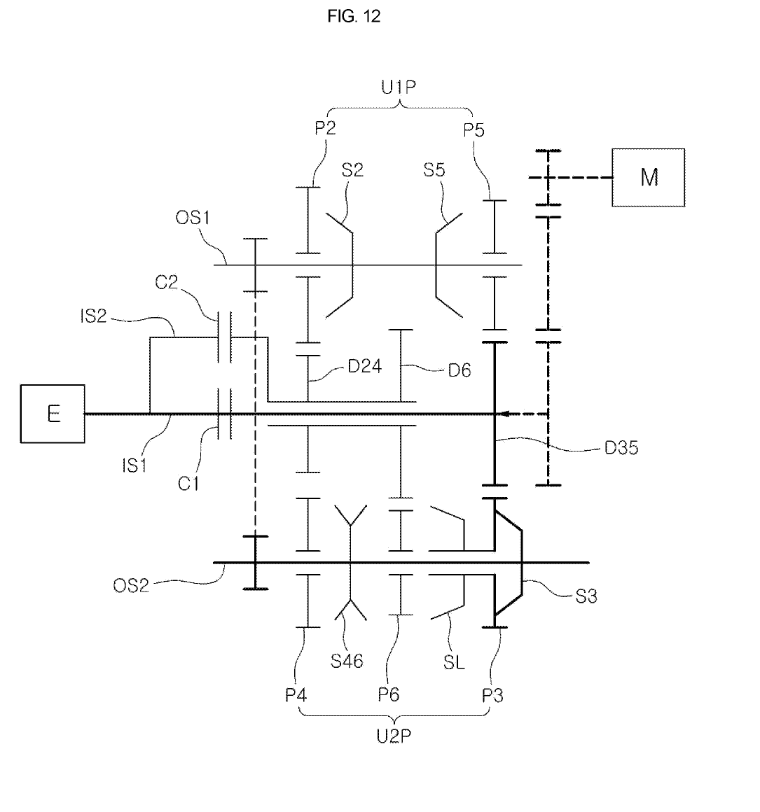

In the case of the HEV 3-stage, as illustrated in FIG. 12, the 3-stage synchronizer device S3 is operated and the first clutch C1 is engaged to transmit the power of the engine E to the second output shaft OS2 through the 3-stage gear set. Here, the motor M may naturally transmit auxiliary power to the first input shaft IS1.

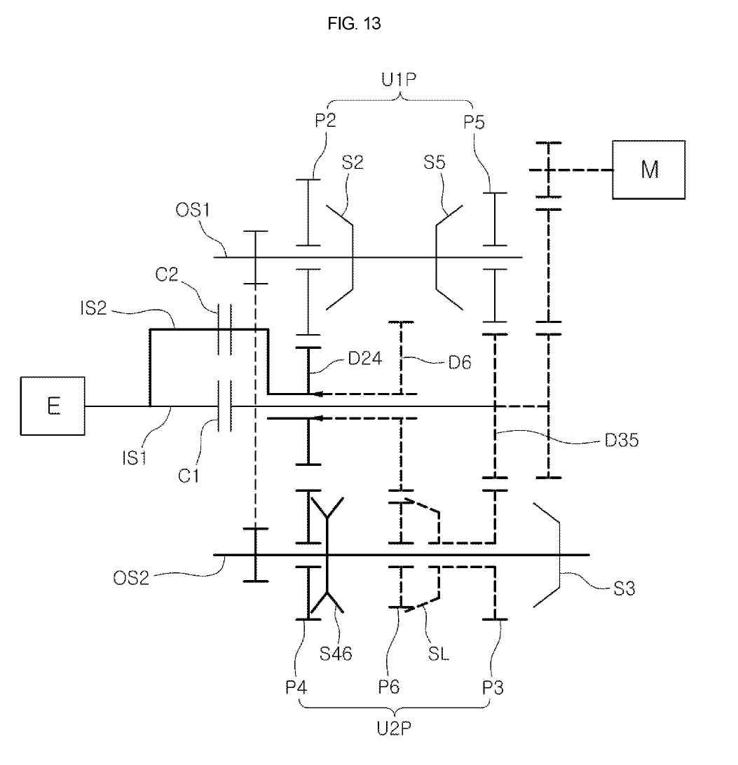

In the case of the HEV 4-stage, as illustrated in FIG. 13, the 46-stage synchronizer device S46 is operated by the 4-stage driven gear P4 and the second clutch C2 is engaged to transmit the power of the engine E to the second output shaft OS2 through the 4-stage gear set. At this time, if the auxiliary power is to be transmitted to the motor M, the connecting device SL may be operated.

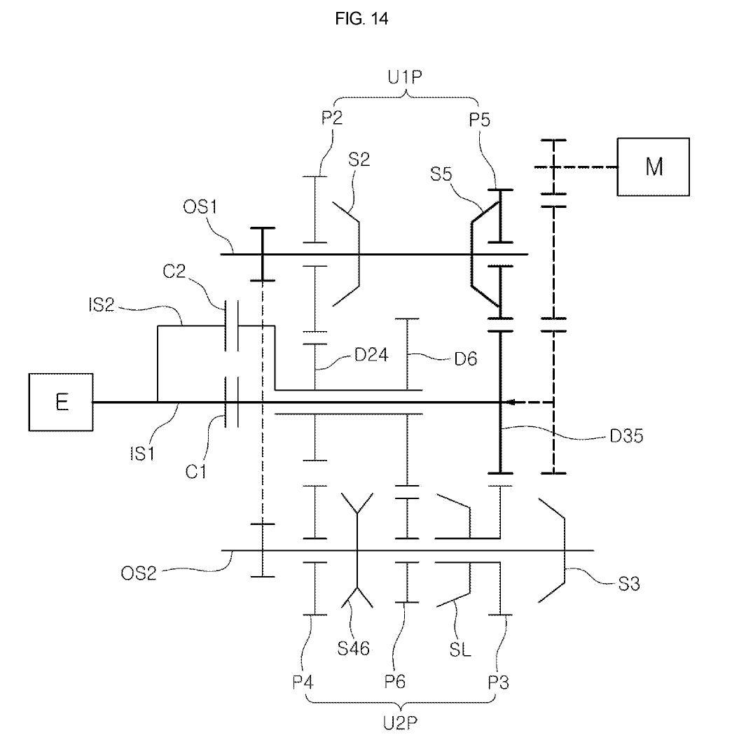

In the case of the HEV 5-stage, as illustrated in FIG. 14, the 5-stage synchronizer device S5 is operated and the first clutch C1 is engaged to transmit the power of the engine E to the first output shaft OS1 through the 5-stage gear set. At this time, the motor M may transmit auxiliary power to the first input shaft IS1.

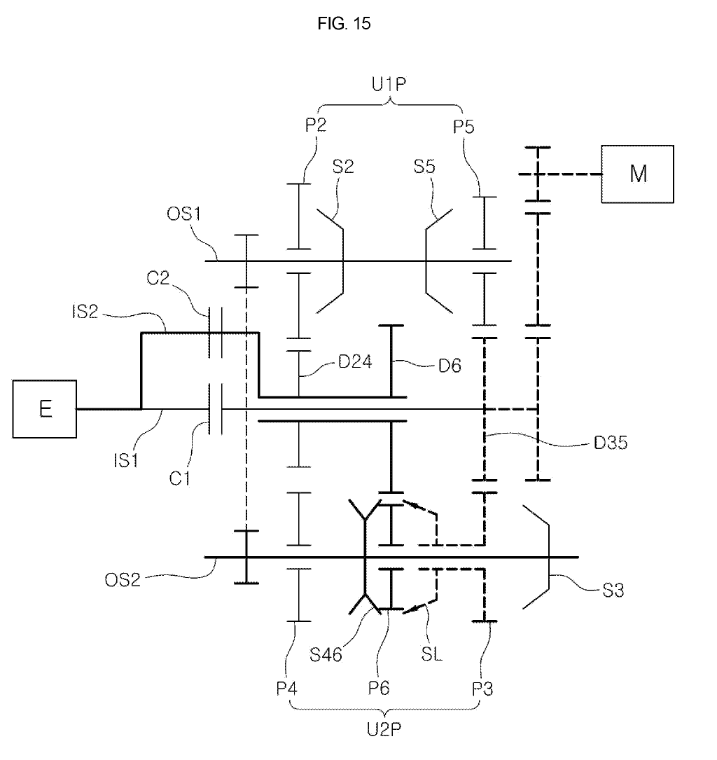

In the case of the HEV 6-stage, as illustrated in FIG. 15, the 46-stage synchronizer device S46 is operated by the 6-stage driven gear P6 and the second clutch C2 is engaged to transmit the power of the engine E to the second output shaft OS2 through the 6-stage gear set. At this time, if the auxiliary power is to be transmitted to the motor M, the connecting device SL may be operated.

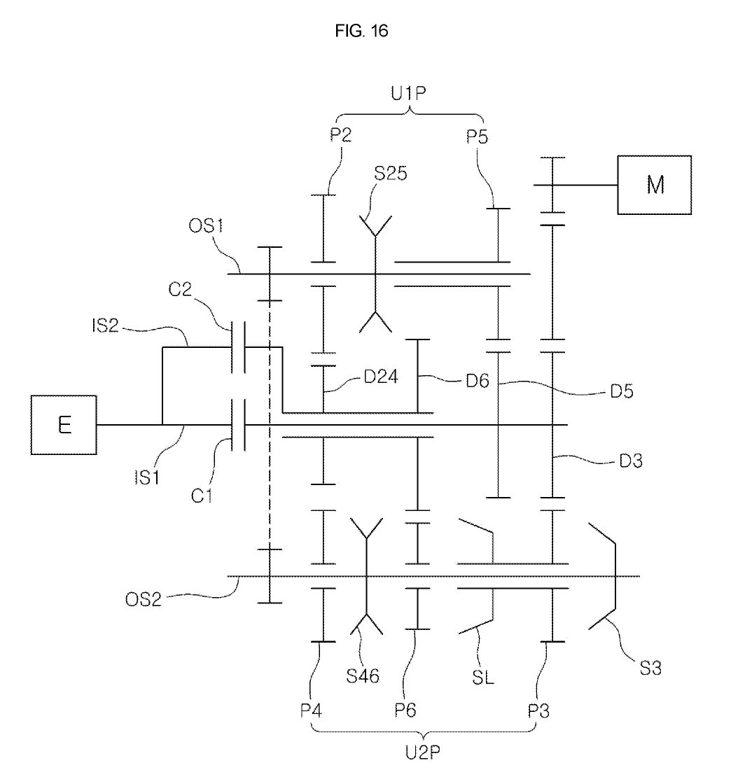

Meanwhile, the transmission for a vehicle according to the present disclosure may be implemented in various forms. FIGS. 16 to 21 are diagrams illustrating a transmission for a vehicle according to second to seventh exemplary forms of the present disclosure.

As illustrated in FIG. 16, the transmission for a vehicle according to the second form may include one 2-stage synchronizer device and one 5-stage synchronizer device and the transmission gear unit connecting between the motor M and the first input shaft IS1 may be provided to be engaged with the 3-stage driven gear P3.

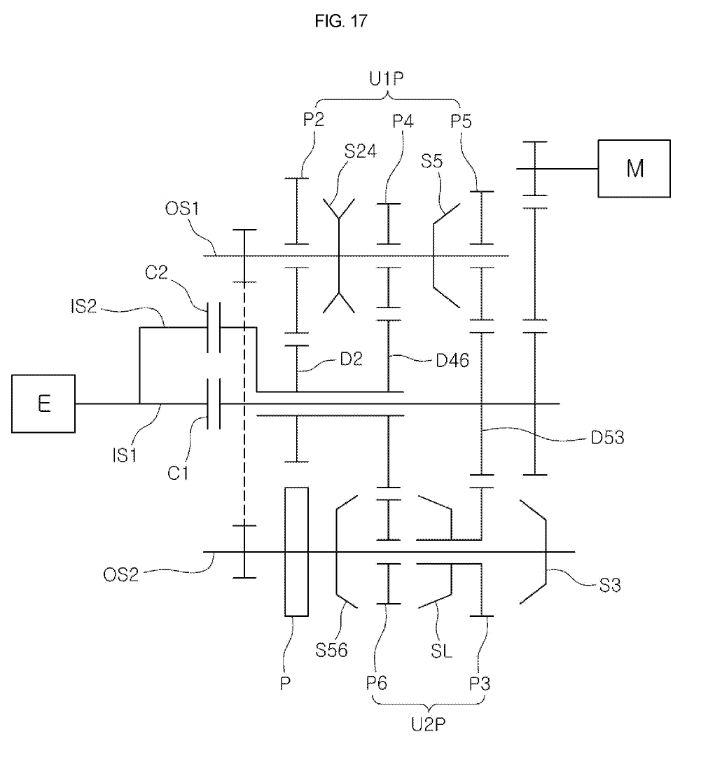

As illustrated in FIG. 17, in the transmission for a vehicle according to the third form, the 4-stage driven gear P4 may be provided on the first output shaft OS1. In addition, the transmission for a vehicle may further include a parking gear P provided on either the first output shaft OS1 or the second output shaft OS2 to prevent the output shaft from rotating.

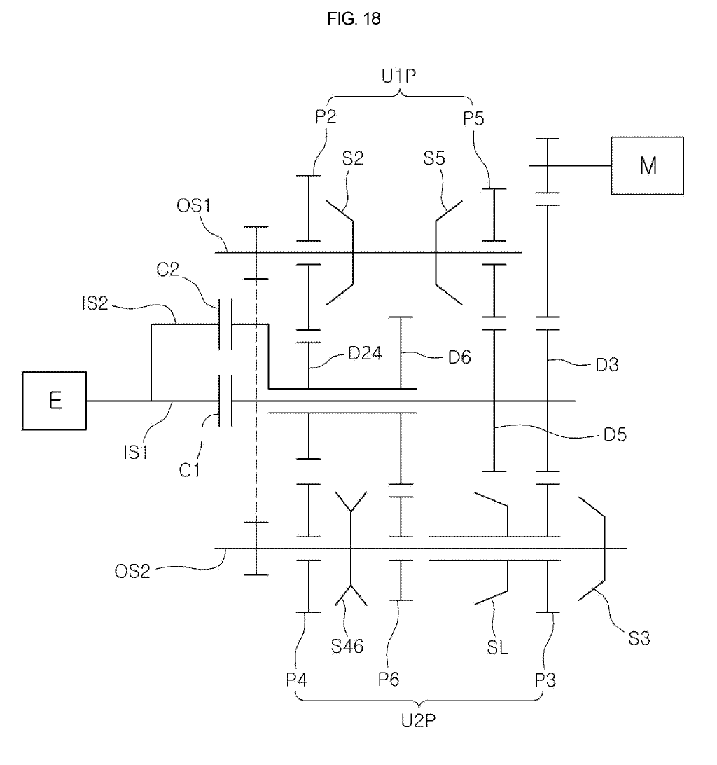

As illustrated in FIG. 18, in the transmission for a vehicle according to the fourth form, the transmission gear unit connecting between the motor M and the first input shaft IS1 may be provided to be engaged with the 3-stage driven gear P3 and engaged with the 5-stage driven gear P3 and a separate 5-stage driving gear D5.

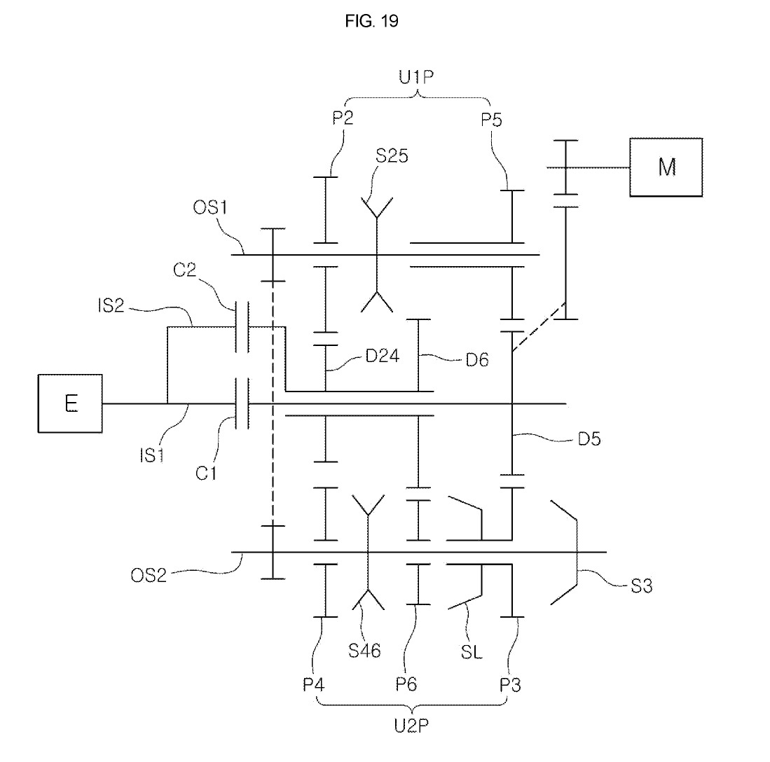

As illustrated in FIG. 19, in the transmission for a vehicle according to the fifth form, the transmission gear unit connecting between the motor M and the first input shaft IS1 may be provided to be engaged with a 35-stage driving gear D35.

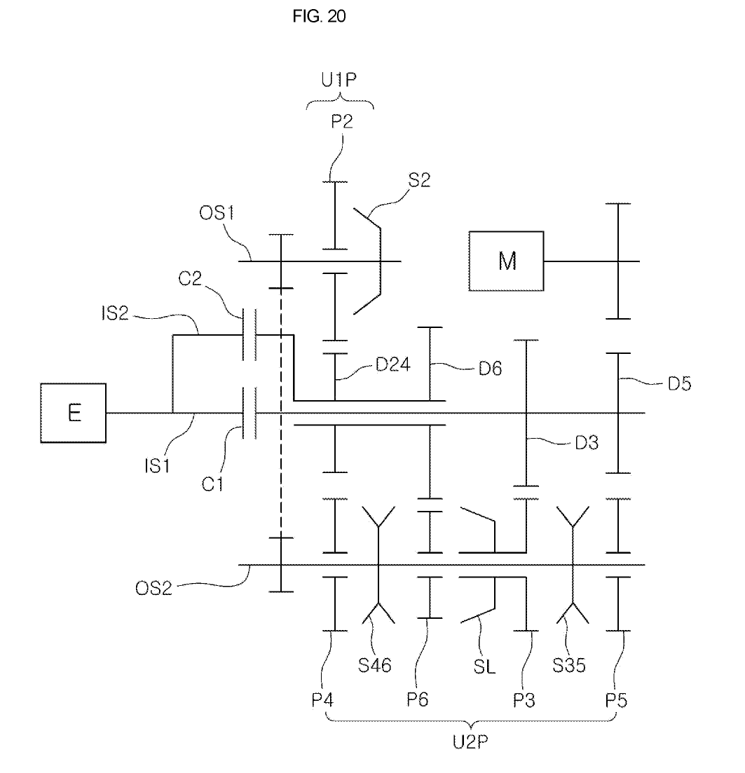

As illustrated in FIG. 20, in the transmission for a vehicle according to the sixth form, the 5-stage driven gear P5 may be provided on the second output shaft OP2. As a result, the number of synchronizer devices may be reduced.

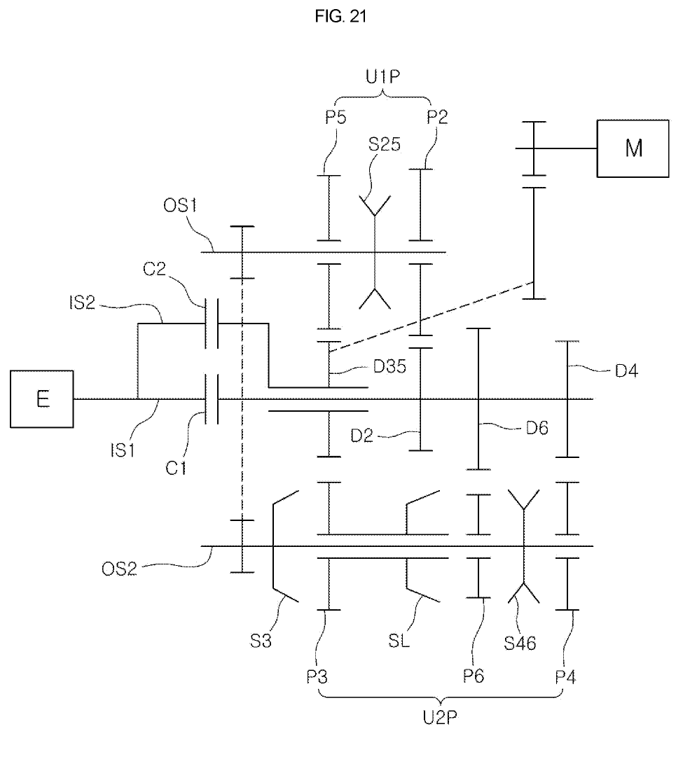

As illustrated in FIG. 21, in the transmission for a vehicle according to the seventh form, the motor M is always connected to the second input shaft IS2 through the transmission gear unit, and a specific shift stage other than the R-stage among the shift gears to be implemented may be provided to control the synchronizer device to connect the single first driven gear (i.e., one single driven gear of the first driven gear units U1P) connected to the first input shaft IS1 to the first output shaft OS1 while connecting the connecting device SL.

According to the transmission for a vehicle having the above-described structure, the transmission for a vehicle can have the relatively simple and compact structure while improving the shift feeling and the ride comfort by reducing the torque interruption, as well as improving the mountability in the vehicle and contributing to the fuel efficiency.

In addition, since the motor is directly connected to the gearbox, the existing engine clutch provided between the engine and the motor can be removed, thereby reducing the volume of the transmission.

Although the present disclosure has been shown and described with respect to specific exemplary forms, it will be obvious to those skilled in the art that the present disclosure may be variously modified and altered without departing from the spirit and scope of the present disclosure.

What is claimed is:

1. A transmission for a vehicle, comprising:
a first input shaft disposed to be selectively supplied with power from an engine;
a second input shaft disposed to be selectively supplied with power from the engine;
a motor disposed to be always connected to one of the first input shaft and the second input shaft through a transmission gear unit configured to transmit power;
a first output shaft and a second output shaft disposed in parallel with the first input shaft and the second input shaft;
a first driven gear unit forming a hollow shaft surrounding an outer side of the first output shaft, the first driven gear unit including a plurality of first driven gears, some of the plurality of first driven gears configured to engage with driving gears provided on the first input shaft and the second input shaft;
a second driven gear unit forming a hollow shaft surrounding an outer side of the second output shaft, the second driven gear unit including a plurality of second driven gears, some of the plurality of second driven gears configured to engage with the driving gears provided on the first input shaft and the second input shaft;
a plurality of synchronizer devices provided on the first output shaft and the second output shaft and configured to connect one of the first and second driven gear units to a corresponding output shaft selected from the first and second output shafts; and
a connecting device configured to selectively interconnecti two second driven gears selected from the plurality of second driven gears, wherein each of the selected two second driven gears is connected to a different input shaft selected from the first and second input shafts.

2. The transmission of claim 1, wherein the first input shaft is connected to the engine through a first clutch, and
wherein the second input shaft is formed as a hollow shaft surrounding an outer side of the first input shaft and is connected to the engine through a second clutch.

3. The transmission of claim 1, wherein the motor is always connected to the first input shaft through a transmission gear unit, and
wherein, among shift stages to be implemented by the transmission, a specific shift stage except a reverse stage (R-stage) is implemented by controlling one of the synchronizer devices configured to connect, among the plurality of first driven gears , a first driven gear connected to the second input shaft to the first output shaft, while the connecting device is interconnecting, among the plurality of second driven gears , the two second driven gears each other.

4. The transmission of claim 3, wherein a number of the first and second driven gears of the first and second driven gear units and is set to be equal to a number of the shift stages to be implemented excluding the specific shift stage and the R-stage.

5. The transmission of claim 1, further comprising:
a parking gear provided on one output shaft selected from the first output shaft and the second output shaft to inhibiting the selected output shaft from rotating.
